(19) United States
(12) Patent Application Publication
(10) Pub. No.: US 2023/0297565 A1
(43) Pub. Date: Sep. 21, 2023

(54) SYSTEM AND METHOD FOR DISTRIBUTION, SEARCHING, AND RETRIEVAL OF DATA ASSETS

(71) Applicant: American Express Travel Related Services Company, Inc., New York, NY (US)

(72) Inventors: Anna Korsakova Bain, East Northport, NY (US); Arijit Ghosh, Edison, NJ (US); Kristen Gonzalez, Long Island City, NY (US); Kavita Gupta, Princeton, NJ (US); Ganesh Iyer, Edison, NJ (US); Kamalakannan Jeevanandham, Bridgewater, NJ (US); Wesley Johnson, Glendale, AZ (US); David Juang, Forest Hills, NY (US); Gita Kolla, Scottsdale, AZ (US); Bimal Ramankutty, Phoenix, AZ (US); Gurusamy Ramasamy, Princeton, NJ (US); Sachin Kale, Edison, NJ (US); Jeremy D Seideman, Brooklyn, NY (US); Amit Sharma, Phoenix, AZ (US); Pratiti Shrivastava, Jersey City, NJ (US); Robin Vetrady, Phoenix, AZ (US)

(73) Assignee: American Express Travel Related Services Company, Inc., New York, NY (US)

(21) Appl. No.: 17/696,798

(22) Filed: Mar. 16, 2022

(51) Int. Cl. G06F 16/242; G06F 16/2457; G06F 16/25; G06F 3/0481

(52) U.S. Cl. CPC G06F 16/2428; G06F 16/24575; G06F 16/256; G06F 3/0481

(57) ABSTRACT

A method, system, and computer readable storage to implement a data marketplace which stored data assets, such as tables, models, variables, etc. All of the data assets (assets) can be searched and retrieved from the data marketplace notwithstanding that the assets can be stored at different locations, in different forms, and in different platforms through an entire big data system. The data marketplace also predicts and suggests assets which will be likely to be relevant to a user's current project.

### BACKGROUND OF THE INVENTION

In the field of data analytics, a user may work with tables, attributes, and many data structures. A user may be required to access multiple databases in order to find the items (e.g., tables) he or she is looking for. In addition, it can be challenging for a user to find the best data items (e.g., tables, etc.) he or she may be looking for working on a project.

Data may not be easily classifiable in the sense that a web page can be. Thus, traditional searching techniques used by commercial search engines would not be applicable to searching and identifying data. Data can be very large, be comprised simply of numbers or other data fields, and may not have human readable qualities that web pages have.

Therefore, what is needed is a user interface, method, and system which enables a user to identify and retrieve their most relevant data items.

### SUMMARY OF THE INVENTION

It is an aspect of the present invention to provide an improved asset distribution system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a block diagram illustrating an exemplary system for storing, reading, and writing big data sets, in an embodiment;

FIG. 2 is a block diagram illustrating an exemplary big data management system supporting a unified, virtualized interface for multiple data storage formats, according to an embodiment;

FIG. 3 is a combined data flow, process, and architecture diagram illustrating a data marketplace implemented on a big data management system, according to an embodiment;

FIG. 4 is a flowchart illustrating an exemplary method of creating a data request, according to an embodiment;

FIG. 5 is a flowchart illustrating an exemplary method of preparing data for distribution on a data marketplace, according to an embodiment;

FIG. 6 is a flowchart illustrating an exemplary method of delivering data to a data marketplace, according to an embodiment;

FIG. 7 is a drawing illustrating an exemplary display output of automated table recommendations, according to an embodiment;

FIG. 8 is a drawing illustrating an exemplary display output of table bookmarks, according to an embodiment;

FIG. 9 is a drawing illustrating an exemplary display input/output of searching a data marketplace, according to an embodiment;

FIG. 10 is a drawing illustrating an exemplary display input/output of searching a data marketplace with auto suggestions, according to an embodiment;

FIG. 11 is a drawing illustrating an exemplary display input/output of searching for a particular type of result, according to an embodiment;

FIG. 12 is a drawing illustrating an exemplary display output of business information for a particular table, according to an embodiment;

FIG. 13 is a drawing illustrating an exemplary display output of technical information for a particular table, according to an embodiment;

FIG. 14 is a drawing illustrating an exemplary display output of security information for a particular table, according to an embodiment;

FIG. 15 is a drawing illustrating an exemplary display output of ownership information for a particular table, according to an embodiment;

FIG. 16 is a drawing illustrating an exemplary display input/output of searching for a particular type of result (model), according to an embodiment;

FIG. 17 is a drawing illustrating an exemplary display output of business information for a particular model, according to an embodiment;

FIG. 18 is a drawing illustrating an exemplary display output of a table health display, according to an embodiment;

FIG. 19 is a flowchart illustrating an exemplary method of automatically displaying suggested assets, according to an embodiment;

FIG. 20 is a flow diagram illustration an exemplary implementation of machine learning applied to search queries, according to an embodiment;

FIG. 21 is a flowchart illustrating how a search query can be processed, according to an embodiment;

FIG. 22 is a flowchart illustrating an exemplary method of how a user can utilize the system, according to an embodiment; and

FIG. 23 is a block diagram illustrating an exemplary configuration of hardware in order to implement a computer, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout. The detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

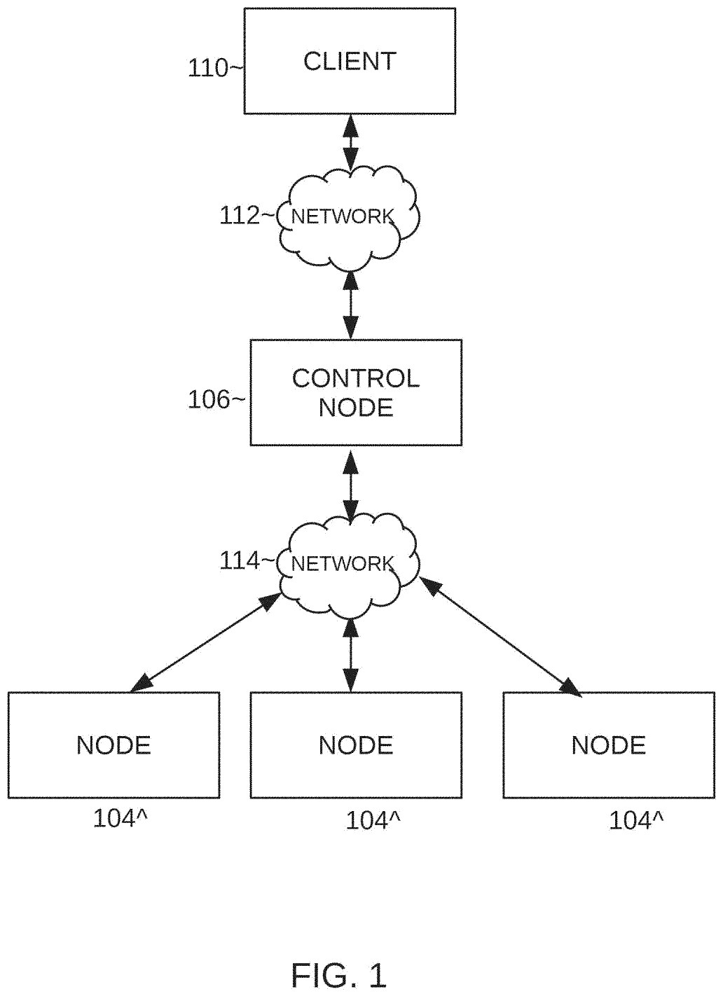

FIG. 1 is a block diagram illustrating an exemplary system for storing, reading, and writing data sets, in an embodiment. The system illustrated in FIG. 1 can be used to search for, access, retrieve, and store data. The system can process “big data”, that is very large quantities of data (e.g., over a million records) almost instantaneously (e.g., over one million records can be processed in less than one second) which clearly cannot be accomplished by any person manually.

Nodes 104, control node 106, and client 110 comprise any devices capable of receiving and/or processing an electronic message via network 112 and/or network 114. For example, nodes 104 may take the form of a computer or processor, or a set of computers/processors, such as a system of rack-mounted servers. However, other types of computing units or systems may be used, including laptops, notebooks, handheld computers, personal digital assistants, cellular phones, or any other device capable of receiving data over the network.

Client 110 can submit requests to control node 106, which distributes tasks among nodes 104 for processing to complete the task. A network can be any suitable electronic link (wired or wireless) capable of carrying communication between two or more computing devices, for example, a local area network using TCP/IP communication or wide area network using communication over the Internet. Nodes 104 and control node 106 may similarly be in communication with one another over network 114. Network 114 may be an internal network isolated from the Internet and client 110, or network 114 may comprise an external connection to enable direct electronic communication with client 110 and the internet. The system illustrated in FIG. 1 can process and ingest hundreds of thousands (or millions) of records from a single data source (or multiple data sources), and nodes 104 can process data in parallel.

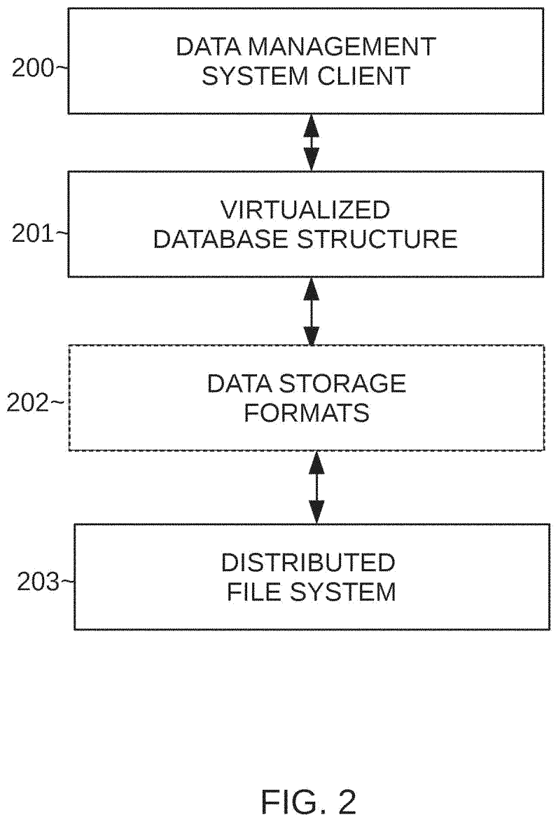

FIG. 2 is a block diagram illustrating an exemplary big data management system supporting a unified, virtualized interface for multiple data storage formats, according to an embodiment.

A data management client 200 may comprise an interface that a user can interact with and use to access and utilize the entire system. The data management client 200 can transmit to and receive data from a virtualized database structure 201. The client 200 can request and access data by requesting variables from the virtualized database structure 201. In the context of the current disclosure, variables can be any type of variable used in computing languages, for example numerical (or text) which can be discrete and continuous, categorical, etc. The virtualized database structure 201 can then access the variables using various interfaces which can retrieve various data storage formats 202 and return the variable(s) to client 200. The virtualized database structure 201 can be a software and/or hardware layer that makes data stored in the data storage formats 202 transparent to client 200 by providing variables on request. The virtualized database structure 201 can provide a uniform interface/access point for different storage formats in the data storage formats 202.

The data storage formats 202 can be utilized by a data warehouse such as HIVE which for example can be built on top of a HADOOP infrastructure (or any other such warehouse and infrastructure). In some embodiments, a cluster computing engine (not pictured in FIG. 2) can also be built on top of the data storage formats 202 in order to implement high-speed large-scale data processing. The data storage formats 202 can also comprise a storage management layer (not pictured in FIG. 2) such as HCatalog which can also support HIVE and any other such languages. Variables may be stored in a single one of the data storage formats 202 or replicated across numerous data storage formats 202 to support different access characteristics. The virtualized database structure 201 can utilize a catalog of the various variables available in the various data storage formats 202. The variables can be cataloged as they are ingested and stored using data storage formats 202. The catalog may track the location of variables by identifying the storage format, the table, and/or the variable name for each variable available through the virtualized database structure 201. All files in the data storage formats 202 can be stored in a distributed file system 203 which are accessible (can be stored and retrieved) by all other parts of the system. The data management system client 200 would ultimately access the distributed file system 203, but not directly, as such access would typically be performed at other layers such as the virtualized database structure 201.

The current application relates to a data marketplace in which data assets (e.g., tables such as a data warehouse table (such as HIVE, etc.), attributes, models, reports, variables, etc., which are also referred to herein as “assets”) can be requested, searched for, created, published, and retrieved. In some embodiments, such data assets can be stored across different systems. In some embodiments, a database can store an entire library of data assets and assign each data asset an identification number which can be stored along with other metadata in a catalog. In such embodiments, the entire library of data assets can be easily accessible to users via a central interface. A user can query the data marketplace which can provide the central interface which can be used to search the entire catalog for relevant data assets. Desired data assets can be seamlessly retrieved by the user at the marketplace notwithstanding these assets may be stored across different databases, platforms, etc. The retrieved data assets can then be used by the user, for example, to program a simple or sophisticated big data project.

For example, a user may wish to implement a query to identify a particular subset of a customers of a company. In such instances, the user will need to identify a relevant table which contains the data needed for the query. In some embodiments, the user can visit the data marketplace and enter a query via the central interface (e.g., using English language search terms) for the table he/she would need. In such embodiments, the data marketplace would respond with a set of tables which are determined to be most relevant by the search engine, upon which the user can inspect different attributes about each table until the user finds the one(s) he/she wishes to use.

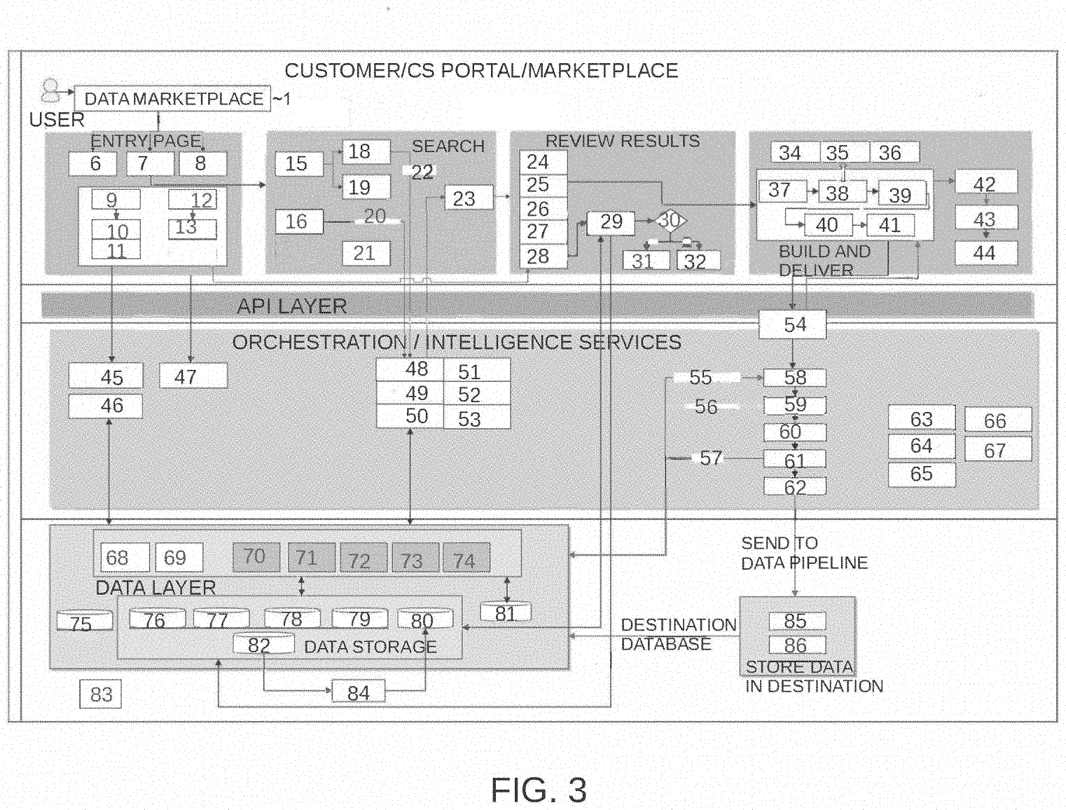

FIG. 3 is a combined data flow, process, and architecture diagram illustrating a data marketplace implemented on a data management system, according to an embodiment.

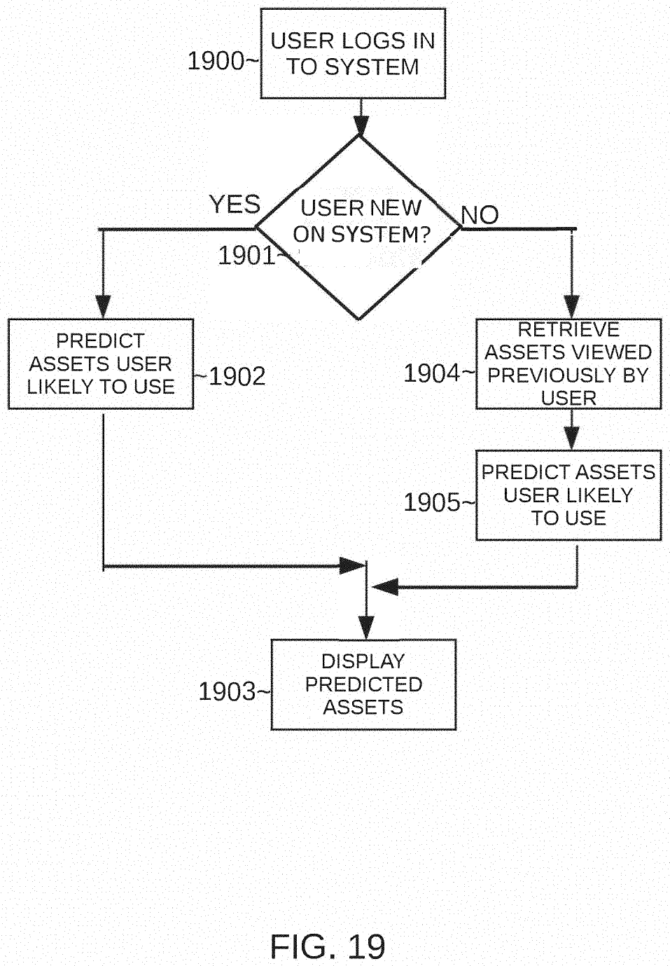

In the block of FIG. 3 entitled “entry page”, a user may access the data marketplace 1. In some embodiments, the system can be accessed via a web browser, application, direct network connection, and/or any appropriate combination of methods available to the user. The user can browse 6 by reviewing descriptions (see “cards” below) of data assets suggested to the user and search 7 for specific data. In some embodiments, the system may learn 8 more about the user so that better suggestions of data assets can be made to the user when the user returns to the entry page. In some embodiments, the user may be a first-time user 9. In such embodiments, the user would have a new user experience to help the new user get oriented and access the proper resources. For example, the first-time user 9 can view popular data 10 which is data that has been searched for or frequently used, and the first-time user 9 can also view popular reports 11 that many users are working with. In some embodiments, the popular data 10 and popular reports 11 would be displayed to the user by widgets 45, 46. In such embodiments, the widgets 45, 46 may automatically request and receive the respective data which forms the popular data 10 and popular reports 11 from a data storage in a data layer. The widgets 45, 46 may transmit the popular data 10 and the popular reports 11 to the entry page so that the user can view the popular data 10 and popular reports 11. In some embodiments, the user may be a returning user 12. For example, the user may have logged in before. A returning user's 12 experience may be based on previous interactions by the returning user. For example, the returning user can be presented with recently accessed data 13 which the user has recently accessed in previous sessions in addition to the popular reports 11. In some embodiments, a customized dashboard can be presented to the user, which gives users a customized dashboard based on each user's needs. For example, such a dashboard can display customized widgets such as new assets a particular user may like, help tips for the system, etc. Also utilized is data quality health which determines scores, anomalies, and measures data accuracy of the data assets. In some embodiments, user reviews of each data asset may be used to measure scores, anomalies, and data accuracies, which can be published to the users. The “entry page” block is also illustrated (in part) in flowchart form in FIG. 19.

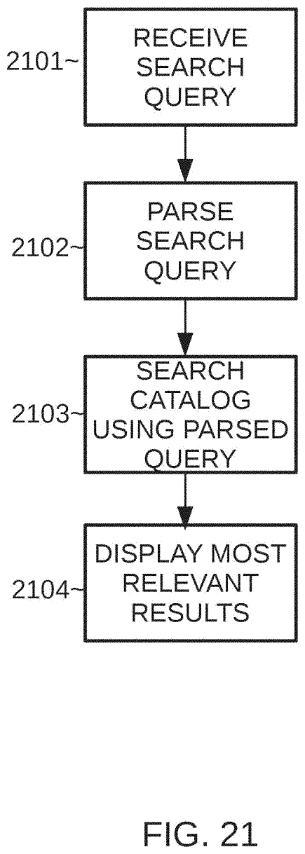

In the block of FIG. 3 entitled “Search”, the user can search 15 for data or data assets 15 by using a search function. In some embodiments, the search 15 can be via a keyword search 18 or natural language search 19. A natural language search 19 is where the query can be entered in terms of a question of using an abstract search query which is analyzed for meaning in order to perform the appropriate search. The keyword search terms (which can be searched for) can include, for example, a table/attribute business term, the internal name of a data attribute or table, or the business-friendly name of that data attribute 22. The user can also or search for pre-built reports 16 that may apply to their data which can include a keyword report name 20 or terms that identify a report. The search block also comprises a query builder 21 which is a utility to create queries for the data by using attributes of the data, so the created queries when searched for would result in the data and other similar data assets. After searching for the entered search terms, the results 23 are determined and the determined results are transmitted to the review results block so they can be viewed by the user. The search block (in part) is illustrated in flowchart form in FIG. 21.

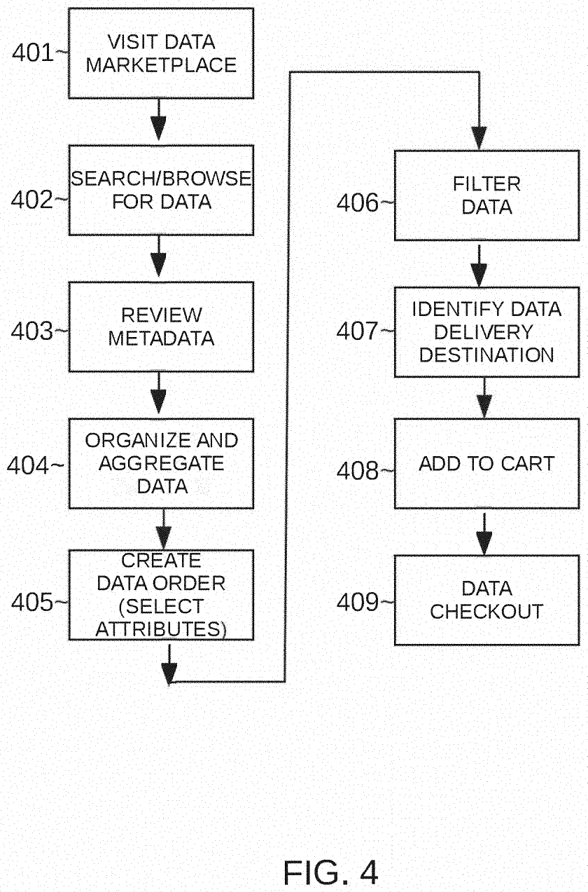

In the block entitled “review results”, the results 23 are displayed to the user who can then review tables 24 which are tables returned from the search, explore the results 25, review business and tech attributes, 26 which are listing of specific attributes that are returned from search, review models 27 which are a listing of appropriate models that are returned from search, and review reports 28 which are a listing of appropriate reports that are returned from search. A business intelligence tool 29 can be used to break the reports up into an easy-to-understand fashion before being displayed. In some embodiments, a determination 30 is made by a security application (not shown in FIG. 3) whether this user has access to the business intelligence tool 29 and the specific report. This can be performed by checking the credentials of the current user to ensure they have been granted access to the business intelligence tool 29 and the specific report (and optionally other assets administered in this layer). If the determination 30 results in a yes, the user is allowed to access 31 the report. If the determination 30 results in a no, the user must request access 32 to the report. The “review results” block is illustrated (in part) in flowchart form in and explained in further detail with reference to FIG. 4.

In the block entitled “build and deliver”, an option is no filter 34 which selects the complete data with all data being returned. The data can also be filtered by a business key 35 (which, for example, may identify particular data such as particular rows/columns in a table). Thus, the business key 35 may filter data so that only a particular subset of the returned data may be displayed which is in contrast to the no filter 34 option which would display all of the returned data. The data can also be filtered using segmentation information 36 (which can be input by the user and which divides the data up into categories). In operation 37, a data order is created in which the user requests the data he/she wants (also referred to as the beginning of the “shopping” phase). Next, in operation 38, the user selects the data they want. Next, in operation 39, the data is added to a shopping cart using shopping cart functionality. In the context of the current disclosure, shopping cart functionality refers to placing one or more desired items into a graphical shopping cart (or other icon) so when the user retrieves the desired items, they can all be retrieved at once. Next, in operation 40, the data delivery destination is determined. Next, the data is checked out 41 and delivered to the delivery destination. After the processing in operations 37-41, the data has been delivered to the user and is ready for consumption 42 and a notification to the user that the delivery is completed can be displayed. Next, the data is reviewed and rated 43 in which the user can provide feedback. For example, a rating such as one star (worst) to five star (best) which can be used to identify which assets are more popular or more useful to affect future search results. In some embodiments, the data may be published/shared 44 so that the delivered data can be used by others in the same business unit or other business units. After the data is checked out 41, the data is transmitted to create a data API 54 which is a data access mechanism so that this particular data can be accessed again easily. The “build and deliver” block is (in part) illustrated in and described in further detail with reference to FIGS. 4-6.

The orchestration/intelligence services layer of FIG. 3 facilitates all of the data requests and retrieval operations and enables processes (such as curating, etc.) to operate by providing a layer between the data and the user interface. In this way, the user does not have to interact directly with the data layer which would be very cumbersome. The widgets 45, 46 can operate by identifying which data is needed, retrieving the requested data, running processes to evaluate the requested data, and then providing outputs which are then piped back to a different layer (e.g., the user interface layer which displays results). There can be advanced recommendations for widgets 45 which is underlying logic to present recommendations to users. There can also be persona driven widgets 46 which contains underlying logic to present recommendations based on the user's role. There can also be personalized results 47 which contains underlying logic to present recommendations based on the user's previous interactions. The orchestration/intelligence services layer also can determine and store accurate search results 48 by performing the search logic, an order of search results 49, related search results 50, a data summary 51, data segmentation info market/product 52 (in which market and product restrictions sometimes require the data to be broken into separate pieces), and aggregation of data results 53 (after all processing, all of the results are put together into a singular view). An interface for a data warehouse 55 (e.g., YELLOW BRICK) can be used to access the data stored in the data storage. The interface can retrieve storage catalog data 56 which is the listing of data in the data storage and write to a curated dataset catalog 57 which is the listing of datasets. A query generator 58 is a utility to create the underlying query (different from a search query as discussed herein) that will access the desired data from the data storage layer (e.g., this is at a lower level query and may include machine specific constructs such as IP addresses, etc.), then data acquisition 59 is a process to bring data into the data interface for a data warehouse 55 for use. Then data preparation 60 (rules/format/aggregation etc.) processes the data (which was retrieved from the data storage) to manipulate it for later use. Then data curation 61 and catalog is performed which accesses the curated dataset catalog 57 to determine which data is needed and where it can be found. Then data order fulfillment 62 is performed in which the data retrieved from the data storage that is published (by including the data in the dataset catalog 57) and made available to the users. The orchestration/intelligence services layer also comprises an intelligent decision service 63 which performs an automated routing of data requests, and which has underlying functionality to handle data requests efficiently. The orchestration/intelligence services layer also comprises a data discovery and orchestration services 64 function and also an automatic data ingestion 65 which handles data movement and data persistence. The orchestration/intelligence services layer also comprises a unified data consumption and distribution service 66 which can assist with unifying and distributing data, and a virtualization data integration enterprise 67 which can integrate LOB (line of business) and domain data.

The data layer comprises business metadata 68 (such as business applications and uses for respective data assets), technical metadata 69 (such as technical attributes of data assets for example timestamps, version number, size, source variables, etc.), domain catalog 70 (certain domains where data assets may be located), reporting catalog 71 (catalog of miscellaneous data that can be used by the system), storage catalog 72 (where data assets can be stored), model catalog 73 (catalog of models), and curated dataset catalog 74 (catalog of data assets which have been curated). Collibra 81 (a data governance tool) can interface with these catalogs and metadata to facilitate access. Also present in the data layer is cloak logs 75 which is an internal access and permissions tool.

The data layer also comprises a data storage which can comprise storages such as memSQL 76 (a data storage technology), YELLOW BRICK 77 (a data storage technology), HIVE 78 (a data storage technology), cloud 79 (data stored in cloud based media), JETHRO 80 (a data storage technology), and ODL 82 (Organized Derived Layer) which refers to a table that has been constructed from data based on rules/processes and is ready for consumption. Also present is security 83 application to ensure that there is no unauthorized access, and transformations 84 (MAGELLAN) which is a data analysis and transformation tool. MemSQL 76, YELLOW BRICK 77, HIVE 78, cloud 79, JETHRO 80, and ODL 82 are not all required and can be configured by the system architects as needed. Data warehouse interface 55 can directly (or indirectly) communicate with MemSQL 76, YELLOW BRICK 77, HIVE 78, cloud 79, JETHRO 80, and ODL 82 to retrieve any data assets needed. The curated dataset catalog 57 can also be retrieved from any of MemSQL 76, YELLOW BRICK 77, HIVE 78, cloud 79, JETHRO 80, and ODL 82 and is then the curated dataset catalog 57 is made available to any other processes as needed.

Coming from data pipeline (from operation 62 when the data order is fulfilled), is an application block used to store the data and metadata in its destination. This block comprises metadata 85 which is a description of the data, e.g., source, name, data type, permissions, etc.) and the data itself 86. The metadata 85 and the data itself 86 gets routed to the destination data storage.

FIG. 4 is a flowchart illustrating an exemplary method of creating a data request, according to an embodiment. This process can be entirely automated and thus is performed automatically. This process can be used to create a data asset which may not already exist.

The method can begin with operation 401, wherein a requestor can visit a data marketplace. The user may log in or set up an account if it is the user's first time visiting the data marketplace and does not yet have credentials to log in. In some embodiments, the user can use a web browser to access the data marketplace. In other embodiments, the data marketplace may be accessed through a direct (non-web based) link.

From operation 401, the method proceeds to operation 402, wherein the requestor would enter search terms to search/browse for available data. Relevant data would be displayed based on the search terms. The search terms may be provided by the requestor in numerous forms, such as a keyword search, natural language search, etc. The requestor can also search by use cases (ideal applications for the desired data asset), which would not be present in the data itself but stored in metadata. For example, the requestor desires to find assets related to identifying makes of vehicles which get good mileage. A particular data asset may have a table of miles driven and gas used, with a use case description of “table can be used to determine miles per gallon for different vehicle types.” While the data asset would not be easy to find performing a search using the data only, searching for a text string of “miles per gallon” or even “vehicle types” would identify this use case (stored in the metadata for the data asset) as relevant and thereby returning the data asset in the search results. The available data and its respective metadata would be displayed so the requestor can review.

From operation 403, the requestor would review the metadata for the data available. The metadata would contain information about the data available and would comprise, but not be limited to, the following: the type of data available, location of data, the manner the data is stored, size of the file, description of how the data can be used, etc.

From operation 403, the method proceeds to operation 404, wherein the data can be automatically organized and aggregated (for example using a relevant data analysis tool such as DATA360). This provides context for the data and using said context to make the overall data usage more user-friendly.

From operation 404, the method proceeds to operation 405, wherein the requestor selects attributes he/she wishes to include in a new data set. The data assets returned in the search results may contain more attributes (e.g., variables, etc.) than needed by the requestor. In such instances, the requestor can identify which attributes he/she only wants to include in the new data set.

From operation 405, the method proceeds to operation 406, wherein the available data is filtered so that only the attributes selected by the requestor are included. For example, if only part of the data retrieved is relevant to the requestor, the unnecessary data can be filtered out to reduce the size of the final data product.

From operation 406, the method proceeds to operation 407, wherein the requestor identifies the destination where the data is to be delivered (e.g., particular storage location on the system, platform, etc.)

From operation 407, the method proceeds to operation 408, wherein the requestor would add the data request to his or her cart. This is “shopping cart” functionality which would be employed for the acquisition of data.

From operation 408, the method proceeds to operation 409, wherein the requestor checks out and the request is transmitted to an application programmed for the curation and publication of the data.

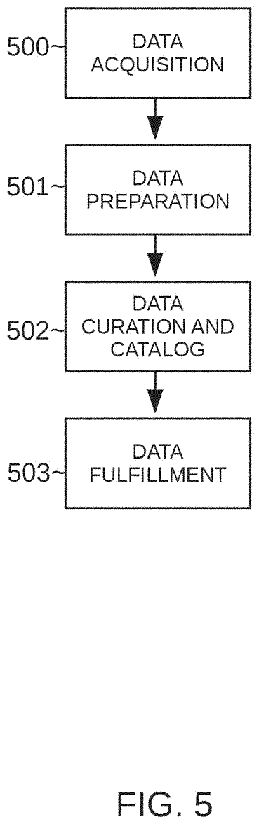

FIG. 5 is a flowchart illustrating an exemplary method of preparing data for distribution on a data marketplace, according to an embodiment.

In operation 500, the request transmitted from operation 409 is received. The required data is then acquired from all relevant sources across the system. If particular data is not available, it can be created from other assets that already exist that can be used to generate the required data. For example, consider that the required data includes wavelengths of light for different colors, but this required data has not yet been acquired. If this particular data exists as part of a separate data asset, then the needed data can be extracted from the separate data asset and then combined with the current data.

From operation 500, the method proceeds to operation 501, wherein the data is prepared for its final packaging. What is necessary for the request is kept while additional data that is not needed can be discarded. The data can be cleaned and duplicated, and irrelevant incomplete data can be discarded. The formats of all of the data can be converted/corrected to the proper format.

From operation 501, the method proceeds to operation 502, which completes the data curation and cataloging. The data curation process comprises having the system retrieve the data, and after preparing the data, presenting it to the user in the manner they want, (e.g., creating their table). A main catalog which contains all of the entries for all of the data assets on the system is updated to include the new data asset that was created. The search engine can now access this main catalog with the newly added entry for this data asset so future users can locate and retrieve this particular data asset. This data asset is now available to future users without the future user (which can be a different user than the one who created the data asset) having to create the data asset all over again.

From operation 502, the method proceeds to operation 503, which completes the data fulfillment. This comprises informing the requestor that their table is ready and providing them access (and others who are permitted to access this data asset and have located and requested to retrieve this data asset).

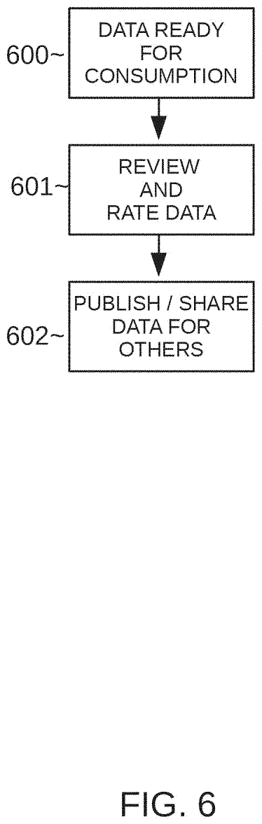

FIG. 6 is a flowchart illustrating an exemplary method of delivering data to a data marketplace, according to an embodiment.

In operation 600, the data asset that was created (e.g., table, etc.) using the methods in FIGS. 4-5 is now ready for consumption.

From operation 600, the method proceeds to operation 601, wherein the data asset is reviewed and rated. The user can provide feedback on their data to train the models in what should and should not be returned. These reviews are then used to rank search results for future users and to also determine what to automatically suggest for future users. For example, highly rated data assets would appear higher in search results and would be more likely to be suggested.

From operation 601, the method proceeds to operation 602, wherein the data asset is published and shared on the system so other users can retrieve it. The main catalog is now updated with all of the metadata about the new asset and the data asset is now available to be retrieved by other users searching on the system for data assets.

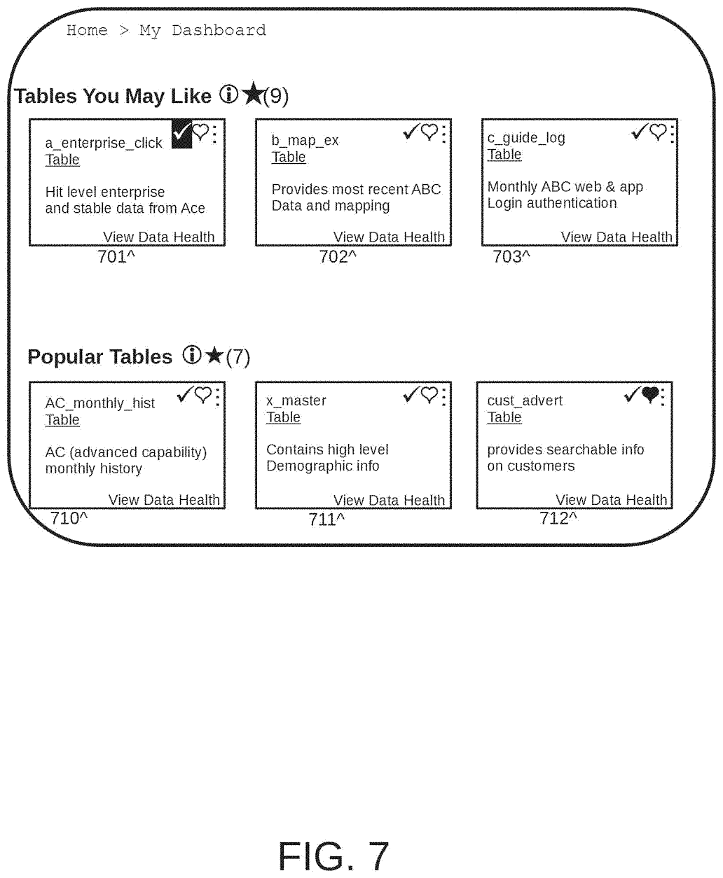

FIG. 7 is a drawing illustrating an exemplary display output of automated table recommendations, according to an embodiment.

When a user visits the data marketplace, (see operation 1900 and the “entry page” block from FIG. 3), automated recommendations of data assets can be displayed to assist the user in finding what he/she needs. The data assets can be displayed in the form of “cards” so the user can easily evaluate each of the data assets (although the data assets can also be displayed in a list form as well). Each card can represent a data asset and contains the name of the asset as well as the type of asset (e.g., table, model, etc.) and a description of the asset. Each displayed data asset (whether displayed in card or list form) can be selected so further details about the asset can be displayed. The first row of cards are suggested asset cards 701, 702, 703 which include suggested assets. These suggested assets may be selected specifically for the particular user in order to provide assets the user would likely want to use. Each card can have a checkbox in the upper right in order to select the card; a bookmarking button (the heart shaped icon) to bookmark the card; an option menu (the three vertical dots) to bring up more information about the card/model.

Suggested assets can be determined in a number of ways. For example, if this is the user's first time using the system, information about the user can be determined (e.g., from the user's name and login credentials, or the system can look up the user's name in an employee table to determine the user's department). Suggested assets can be determined by using a list of associations of particular assets and departments within the organization. Suggested cards can also be determined by tracking which assets are popular among different departments in the company/organization, and then using the most popular assets from the user's respective department as the suggested cards.

If the user has already used the system before, then the system can retrieve assets that the user has previously looked at. These assets can be selected as suggested assets (which can then be displayed as suggested asset cards). In addition, assets that are related to the assets that were previously viewed could also be displayed as suggested asset cards. For example, if a user on his/her last visit to the data marketplace viewed table X and other users who view table X also frequently view or request table Y, then table Y can be displayed as a suggested asset.

What can also be displayed are popular assets 710, 711, 712, which are assets that are frequently used by other users of the data marketplace regardless of the particular user's role or previous history.

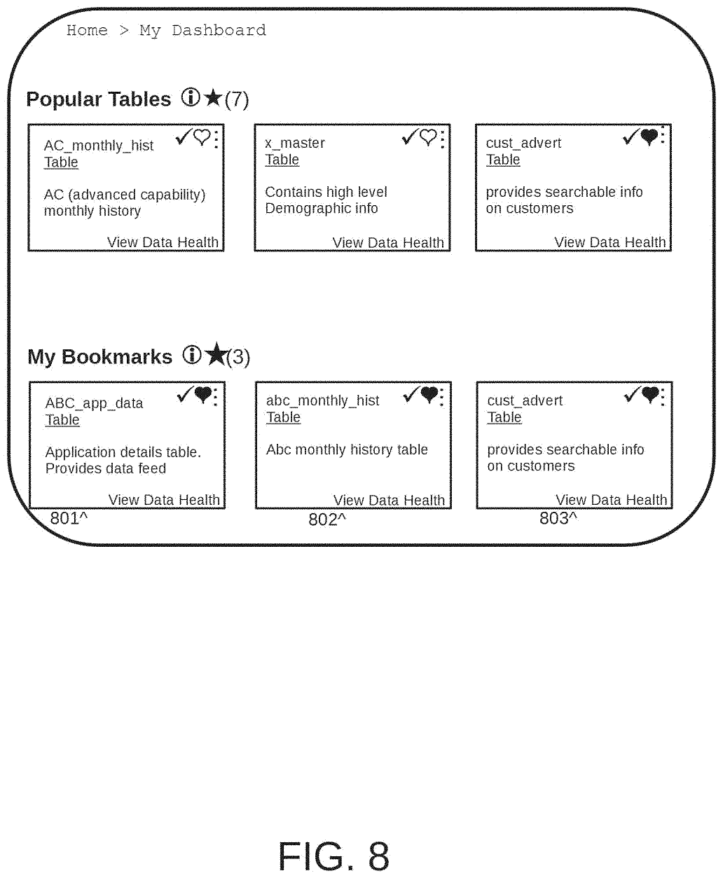

FIG. 8 is a drawing illustrating an exemplary display output of table bookmarks, according to an embodiment.

When a user visits the data marketplace and views assets that the user finds relevant, the user can bookmark them (use a graphical user interface to select them such as clicking the heart icon) which will save the asset so that the user can view all of his/her bookmarked assets 801, 802, 803 later on. A user can “unbookmark” a data asset by clicking the heart icon again on the respective card.

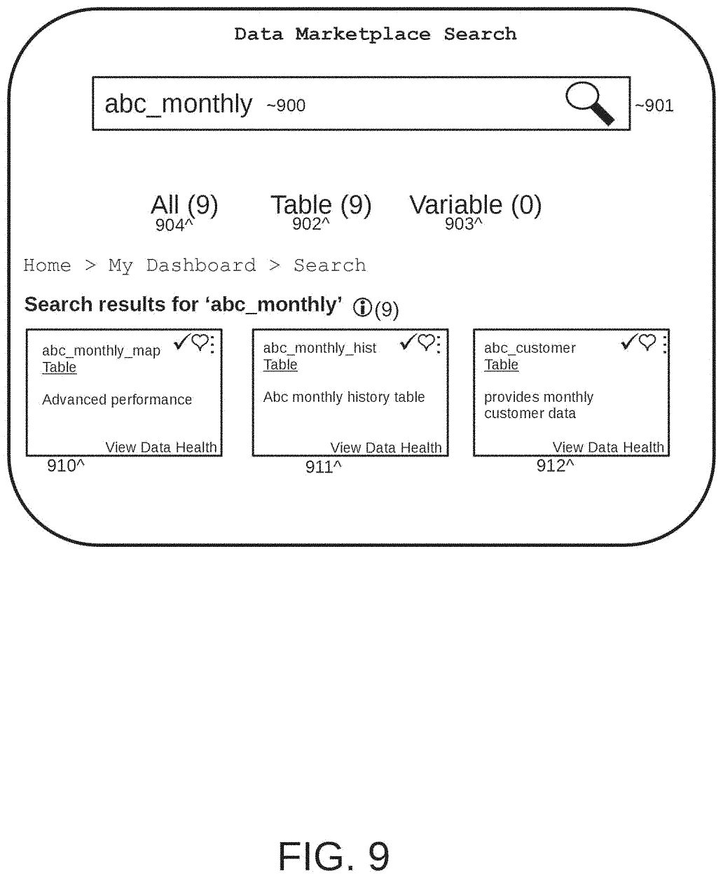

FIG. 9 is a drawing illustrating an exemplary display input/output of searching a data marketplace, according to an embodiment.

A search query 900 can be entered in a search box 901. The search can be limited to particular data asset type by selecting particular asset types (e.g., “table” 902, “variable” 903) or the search can be universal to all asset types (“all” 904). The search results can be displayed in the form of a list (not pictured) or cards 910, 911, 912 which contain information about each asset. For example, clicking “table” or “variable” would limit the search results to that particular asset.

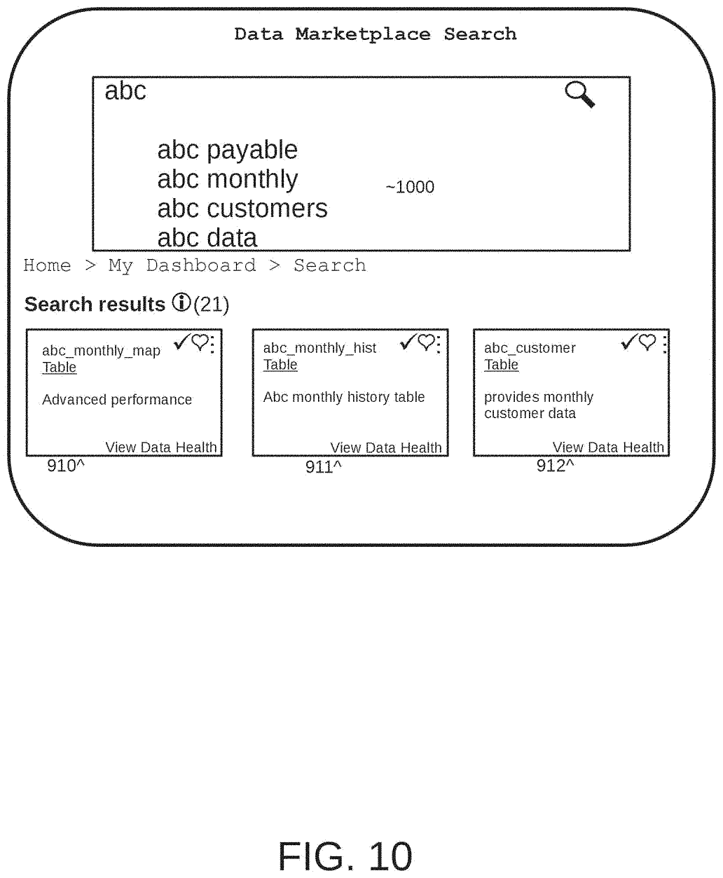

FIG. 10 is a drawing illustrating an exemplary display input/output of searching a data marketplace with auto suggestions, according to an embodiment.

Based on the keyword typed in, autosuggestions 1000 are displayed which are predictions of what the user may wish to type in. Also displayed alongside each autosuggestion is the number of results that query would generate if submitted. The user can simply click on any of the autosuggestions and that autosuggestion will then be searched for (as if the user typed in that autosuggestion as a search query).

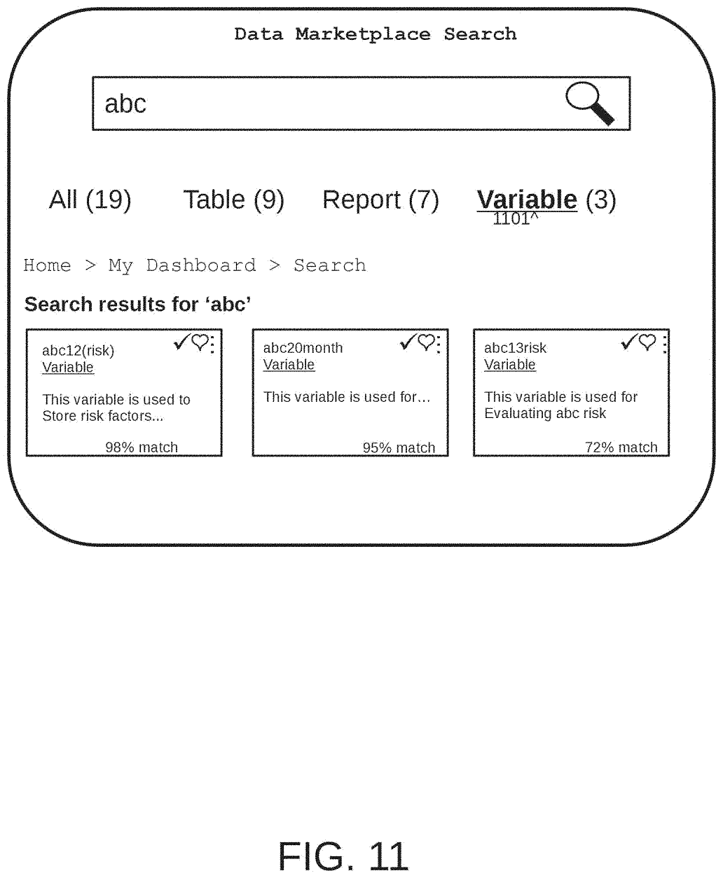

FIG. 11 is a drawing illustrating an exemplary display input/output of searching for a particular type of result, according to an embodiment.

The user searches for a particular search query and a plurality of cards are displayed which are the most relevant assets for the search query, each card displaying metadata for a particular asset. Note that the modifier “variable” 1101 is selected, meaning that only results (data assets) that are the type “variable” will be displayed.

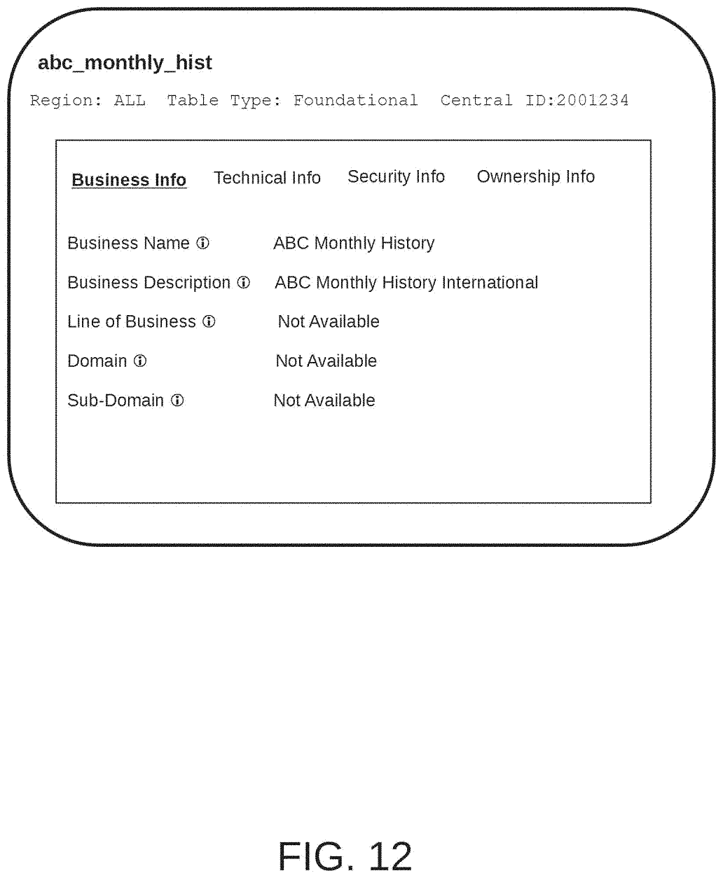

FIG. 12 is a drawing illustrating an exemplary display output of business information for a particular table, according to an embodiment.

When a card is clicked (e.g., the cards displayed in FIG. 10), a more detailed view of that asset is displayed such as what is shown in FIG. 12. The more detailed view can help the user decide if this is the right data asset for him/her to use. Note that each asset can have attributes such as a region (where the asset will be available), a type of the asset, and an identification number (all shown in top). The identification number is important because the identification number can be used to reference all of the assets in the system, and each asset would have a unique identification number. Each asset would also have categories of information, including business information, technical information, security information, and ownership information. Each of these categories of information can be displayed by clicking on the appropriate identifier (e.g., “Business info”, “Technical info”, “Security info”, “Ownership info.”)

FIG. 12 shows the business information for this particular asset (“abc_monthly_hist”). This includes the business name, business description, line of business, domain, sub-domain. The domain can be a broad identifier and the subdomain can be a narrower thing falling under its domain. For example, a domain can be “product” and the sub-domains for this domain can be: “merchant product”, “card product”, “loyalty product”, “travel product”, “non-card product”, “prepaid product.”

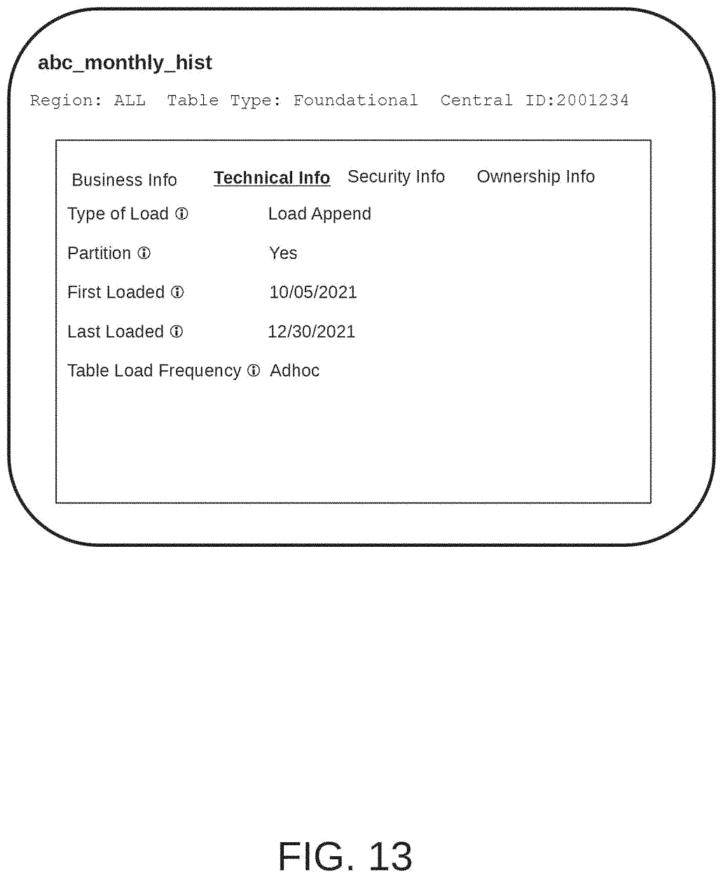

FIG. 13 is a drawing illustrating an exemplary display output of technical information for a particular table, according to an embodiment.

The technical information for each asset can include a type of load on the system, whether it is partitioned, the date it was first loaded into the system, the date it was last loaded (accessed), and the table load frequency.

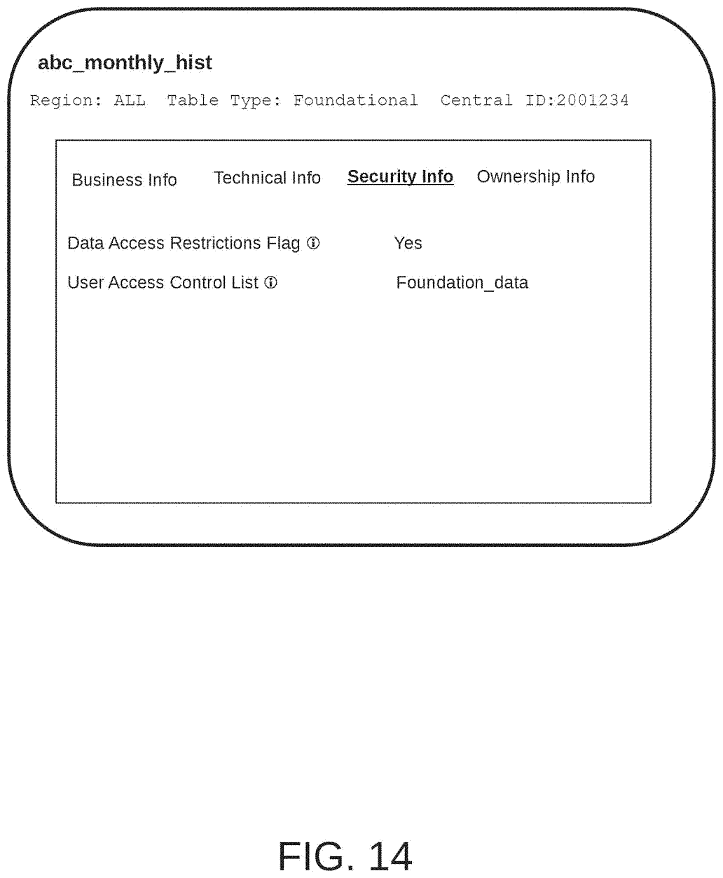

FIG. 14 is a drawing illustrating an exemplary display output of security information for a particular table, according to an embodiment.

The security information includes data access restrictions flag (whether the asset has any restrictions on which users can access it) and user access control lists (a list of which users have access or don't have access to this asset). Some data assets can be accessible to all users, while other data assets will have data restrictions and will only be accessible to certain users (identified by name, group, function, etc.)

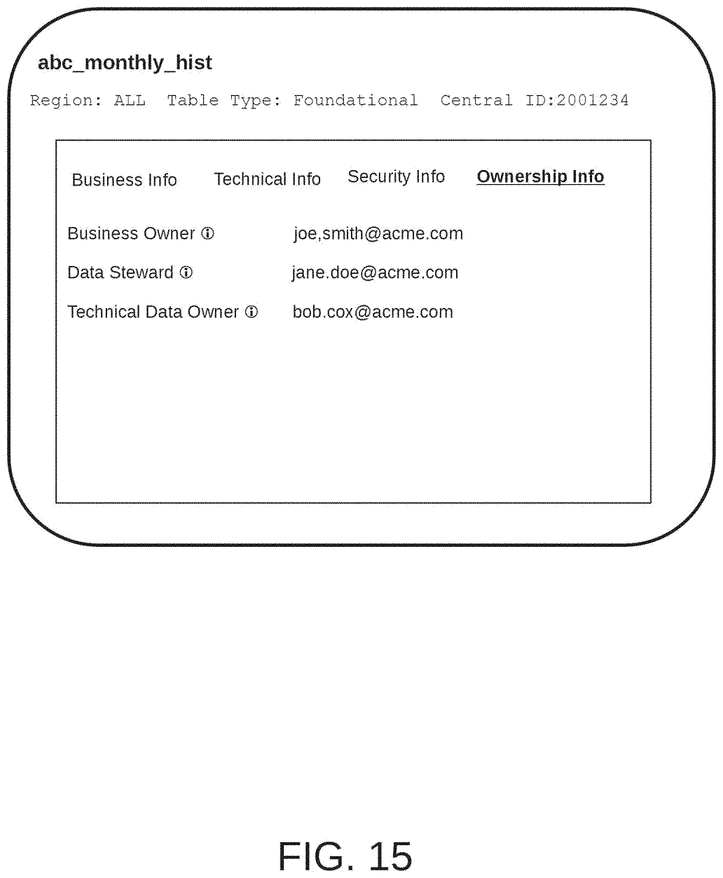

FIG. 15 is a drawing illustrating an exemplary display output of ownership information for a particular table, according to an embodiment.

The ownership information includes the business owner (who owns or controls this asset), the data steward (who created the asset), and the technical data owner (who owns the data used to create this asset).

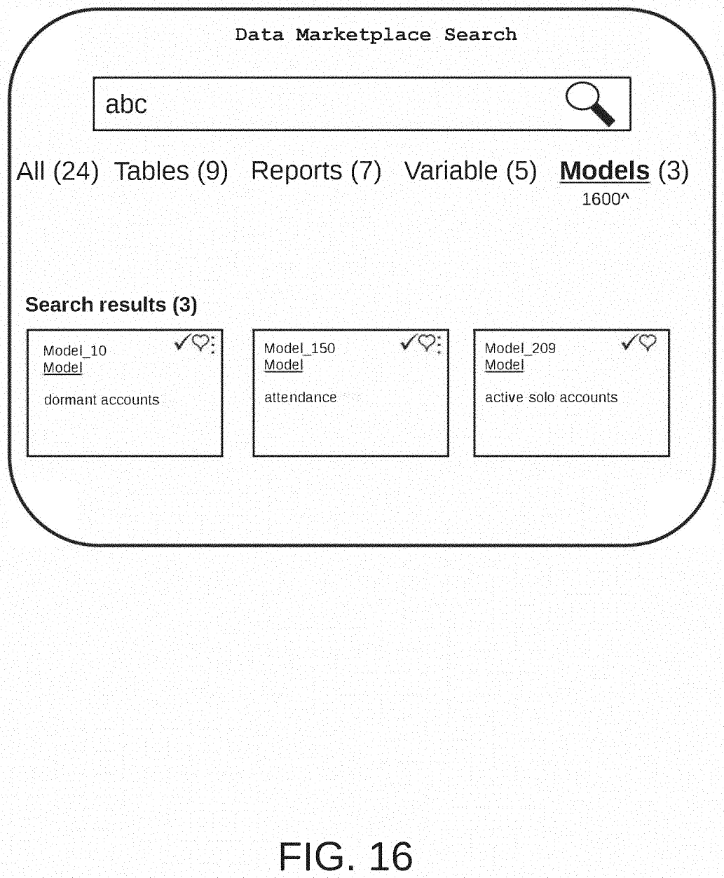

FIG. 16 is a drawing illustrating an exemplary display input/output of searching for a particular type of result (model), according to an embodiment.

On the top row of assets, “models” 1600 is selected, so that all results to the search query are limited to models. A model is code, script, functionality, etc. that can use other assets (e.g., tables) in a more advanced manner to perform particular calculations or functions to return desired results (e.g., a prediction, etc.)

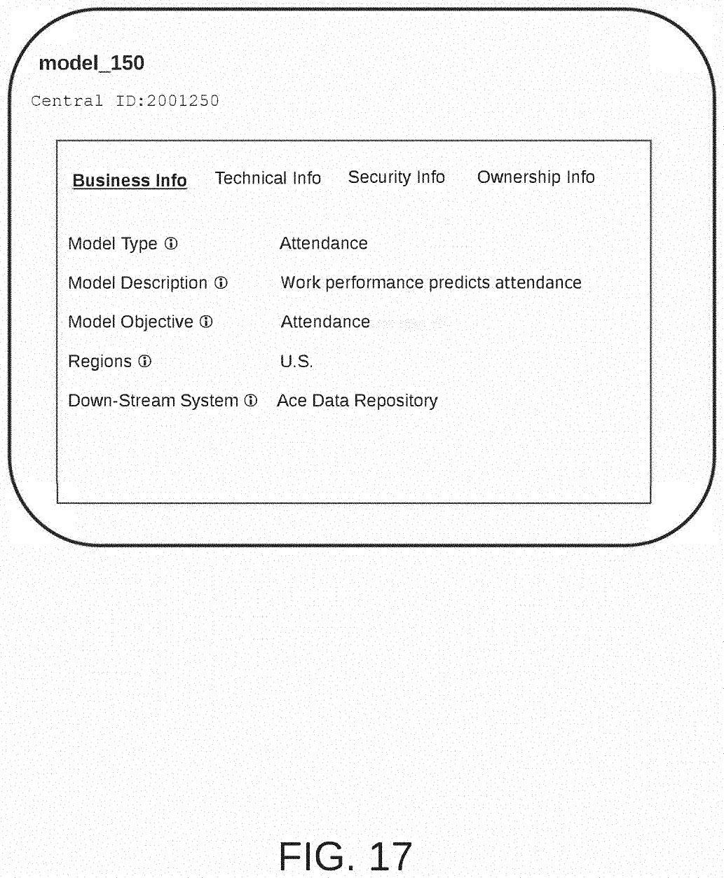

FIG. 17 is a drawing illustrating an exemplary display output of business information for a particular model, according to an embodiment.

One of the cards from FIG. 16 is selected and the more detailed information shown in FIG. 17 is displayed for this particular model (i.e., “model_150”).

The user will typically make search queries, review the details for assets that he/she finds interesting or useful, and then ultimately download the particular assets (e.g., a particular table, model, variable, etc.) that the user wants to work with. The user can then run a query using the retrieved asset(s) using a data warehouse application (e.g., HIVE) or other interface enabling such queries.

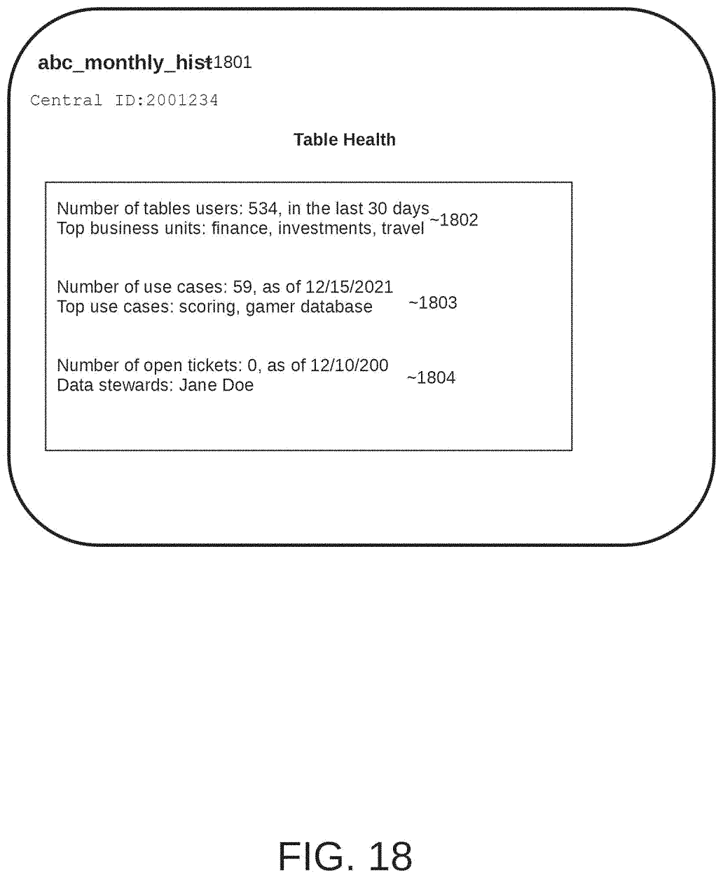

FIG. 18 is a drawing illustrating an exemplary display output of a table health display, according to an embodiment.

For a particular table 1801, this display shows a table's number of users 1802 (the number of users who have actually used this table), a table's number of use cases 1803 (applications this table can be used) and the table's number of open tickets 1804 (a ticket would be submitted by a user if there is a bug or question about the table).

FIG. 19 is a flowchart illustrating an exemplary method of automatically displaying suggested assets, according to an embodiment.

The method begins with operation 1900, wherein the user logs into the system. For example, a user may provide credentials (which can be a username and password, etc.) to log into the system. If the user is a new user, then the user can set up his/her account.

From operation 1900, the method proceeds to operation 1901, which determines whether the user is new on the system (i.e., whether this is the user's first time signing into the system). If yes, the method proceeds to operation 1902. If not, the method proceeds to operation 1904. A flag can be kept on the system identifying if a user has used the system yet or not, in order to determine whether the user is new.

In operation 1902, the system will predict which assets the user is likely to use and display/suggest them (e.g., in the form of cards or lists). This prediction can be done in many ways. For example, the most popular assets in general can be displayed. In addition, information about the user can be ascertained. For example, his department, role, and other attributes can be determined by the user's name and/or his email address. Assets that are popular with other users in the user's department, role, or other attributes can then be displayed as suggested assets to this first-time user. From operation 1902, the method proceeds to operation 1903.

In operation 1904, assets viewed previously by the user can be retrieved. These can be suggested assets (suggested assets are displayed as cards, in a list, or other display mechanism). Suggested assets can also be determined, for example by using the user's role, department, etc. (as discussed with respect to operation 1902).

Assets can have associated assets. For example, if a particular asset was viewed by other users then the other assets that those users also viewed (in the context of the current disclosure, viewed can mean clicking on an asset to bring up the asset's details) can be ranked in popularity of such associated views and the most popular (e.g., top 1-10 such assets) assets that other users looked at can be the associated assets (associated with a particular asset). Thus, associated assets associated with assets that this particular user viewed on previous uses of the system can also be suggested/displayed. From operation 1905, the method proceeds to operation 1903. In addition, queries by other users can be saved, and other users that have similar attributes to the current user (e.g., same department, role, project, etc.) can be identified and results from the identified users' search queries can be suggested/displayed to the user.

In operation 1903, the suggested assets are displayed to the user (either upon log-in or any time during the user's use of the system) so the user can browse them and can click (select) on any of the suggested assets to retrieve more details about them. The assets can be displayed as cards, lists, etc.

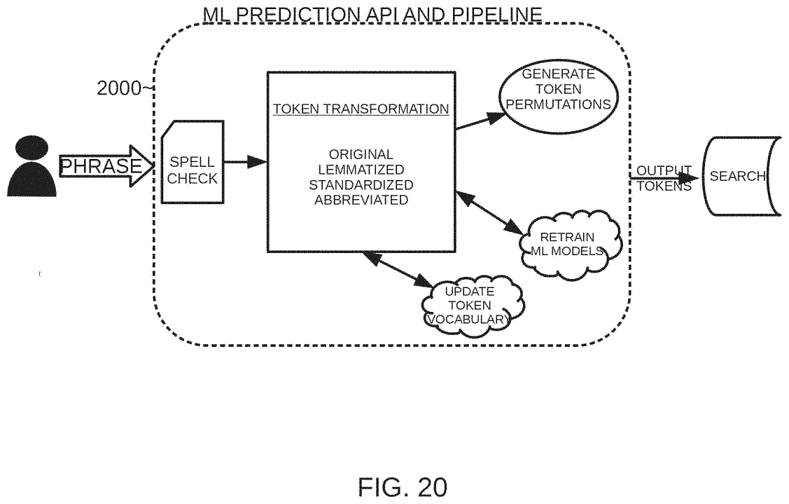

FIG. 20 is a flow diagram illustration an exemplary implementation of machine learning applied to search queries, according to an embodiment. In FIG. 3, see the blocks marked “search” and “review results.”

When a search phrase (also referred to as a search query) is entered into the system, it can be processed 2000 before it is tokenized and output into the search platform itself. The search phrase can undergo a spell check and can be auto corrected before processing continues. The search phrase can then undergo token transformation, which can use the original search phrase (with spelling corrected if necessary), lemmatized, standardized, and abbreviated, in order to generate token permutations. In the context of the current disclosure, tokens are words and phrases which are output to the search engine.

Search phrases can be used to retrain machine learning models. The underlying machine learning models can be retrained based on search history. The search logs can be used holistically to personalize the search experience. Search phrases can be used to update the system's token vocabulary. In addition, the results of a search that the user has chosen to retrieve and/or actually use in an application are tracked, so that the retraining of the machine learning model can also use this data as well. For example, for a particular search query, if three results were generated and the user only used one out of these three results, then it can be assumed that the result that was used was more relevant to the search query than the other two. This type of data can be collected and used to retrain the machine learning system periodically (or immediately each time new such data comes in).

Once the original search phrase is finished processing, the final output tokens are then outputted to the actual search application. For example, if the original search phrase is “cat” the output tokens might be the set comprising cat, cats, feline, felines which are then output to the search engine in order to provide the most comprehensive search results.

FIG. 21 is a flowchart illustrating how a search query can be processed, according to an embodiment.

In operation 2101, the system receives a search query which can be typed into a search box. The search query can include any terms, variables, uses, etc. The search query can also include any attributes of the assets, such as the owner, domain, subdomain, etc. All of these search terms can be included in the main catalog (and/or search catalog) so they can be used to produce more relevant results. The user can also search using keywords for use cases, etc. The use cases can be maintained in the metadata but may not be in the actual data itself. The use cases can be entered by users (or automatically determined), so the system knows which data assets are used for which applications. Thus, use cases (and other attributes of the data asset) can be searched for even though the use cases aren't in the data assets itself.

From operation 2101, the method can proceed to operation 2102, which parses the search query (see FIG. 20 and the accompanying description for how this can be done). The exact search query can be searched, or it can be broken down and multiple search queries can be searched using synonyms, etc.

From operation 2102, the method proceeds to operation 2103, which searches the main catalog (which includes all of the available assets). In addition, a separate search catalog can be maintained which is similar to the main catalog but contains information relevant to searches and thus the search catalog could be used in operation 2103 to search for relevant results. The catalog (or search catalog) would contain searchable terms, such as the type of data the asset contains, use cases for the asset, computations that the asset can accomplish, etc. The search query can be applied both to the data asset itself as well as to the metadata. For example, a search query can be a search for ‘assets which contain variable “experience with sports” and has a use case of “identifying people with tennis experience” ‘which would identify all assets in the catalog (e.g., main catalog, search catalog, etc.) which contain the “experience with sports” variable and which also has in the metadata a use case for “identifying people with tennis experience.”

From operation 2103, the method proceeds to operation 2104, which displays the most relevant result from operation 2103. Note that one or more results determined to be relevant using a particular criteria or methodology can be “favored” in the search results, that is, each result gets a numerical relevancy score (the higher the score the more relevant the result is) and a favored result gets it relevancy score increased by a numerical non-zero value (e.g., 1, etc.) Thus, any method described herein to identify a data asset which can be more relevant to the user, its result in the search results can be favored so the identified data asset appears higher (i.e., towards the top) in the ranking than it would have been if it was not favored. The machine learning algorithm can be used both to identify relevant results as well as to rank the identified relevant results in order of most likely to be what the user is looking for.

The results from the search in operation 2103 can be compared to certain criterion in order to sort the results as most relevant. For example, the most popular assets can be ranked higher. In addition, assets which are determined to be more relevant to the user who entered the search query would be ranked higher. This can be determined by determining the user's role (e.g., department, project he/she is working on) and then identifying assets which are identified as being relevant to those attributes. Queries can also be saved by some or all other users, and other users that have similar attributes to the current user can be determined and results from their search queries can be considered more relevant.

Another way relevant results can be identified is to identify variables that are part of the user's project (for example, the user could have searched for the particular variable, or the user could have viewed an asset that involves the particular variable), and search results that utilize the particular variable can be considered more relevant. The most critical elements of a user's project can be identified, and assets where that critical element plays an important role in the asset can also be considered as more relevant. The system can utilize both the particular user's history as well as the overall history of all users on the platform.

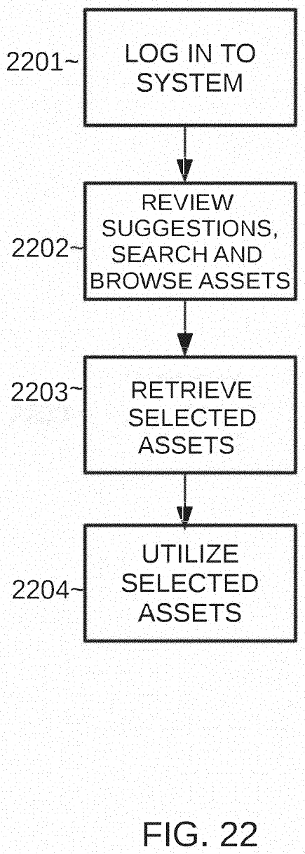

FIG. 22 is a flowchart illustrating an exemplary method of how a user can utilize the system, according to an embodiment.

A user would first log into the system in operation 2201. This can be done as described herein.

From operation 2201, the method would proceed to operation 2202, wherein the user would review suggested assets, search for assets using keywords (and other attributes of assets) and browse assets to find what he/she is looking for.

From operation 2202, the method proceeds to operation 2203. Once the user selects which assets he or she wants to use, the selected assets can be downloaded from the marketplace.

From operation 2203, the method can proceed to operation 2204, wherein the user can the utilize the downloaded assets, for example, in a big data project such as a complex query of data from a table. The assets can be utilized in a number of ways, for example, by accessing the assets, programming and running programmed application which utilizes the assets (e.g., HIVE).

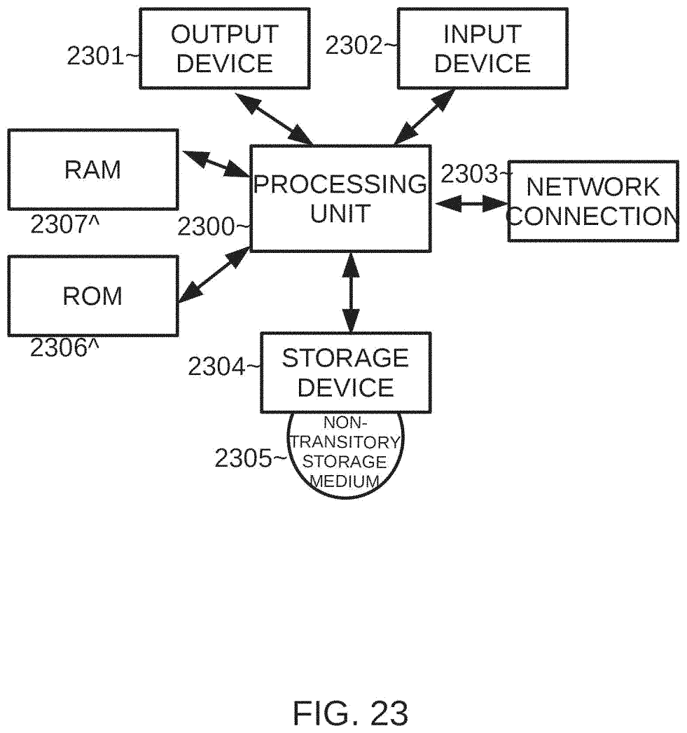

FIG. 23 is a block diagram illustrating an exemplary configuration of hardware in order to implement a computer, according to an embodiment. The hardware shown can be used to implement any node, server, client computer, access point, or any other computing device connected to the system via a wireless connection, etc.

A processing unit 2300 (such as a microprocessor) is connected to an electronic output device 2301 (such as an LCD, touchscreen, monitor, etc.) and an electronic input device 2302 (e.g., touchscreen, keyboard, mouse, buttons, etc.) The processing unit 2300 is also connected to a network connection 2303 which can connect to any computer communications network (such as the Internet, wi-fi, local network, etc.) The processing unit 2300 can also be connected to a RAM 2307 and a ROM 2306. The processing unit 2300 can also be connected to a storage device 2304 (e.g., CD-ROM drive, EPROM, Flash Memory drive, etc.) which can read/write to/from a non-transitory computer readable storage medium (e.g., CD-ROM disc, EPROM memory, Flash memory, etc.)

Note that a computer program can be written and stored on a non-transitory computer readable storage medium to cause a processor or processing unit (such as that in FIG. 23 or any other) to perform any and all of the features, methods, embodiments, etc., described herein. Multiple computers can also operate together and communicate with one another in order to effectuate all such features, methods, embodiments, etc., described herein, whether such multiple computers are located in the same physical location or different physical location.

The systems and methods herein provide support access to a wide variety of layers and data storage formats (e.g., HIVE, SOLR, HBASE) having different support processing approaches (e.g., batch, real-time, process). The connecting lines shown in the various figures contained herein are intended to represent exemplary functional relationships and/or physical couplings between the various elements. It should be noted that many alternative or additional functional relationships or physical connections may be present in a practical system. Any databases discussed herein may include relational, nonrelational, hierarchical, graphical, or object-oriented structure and/or any other database configurations. Any databases, systems, devices, servers or other components of the system may consist of any combination thereof at a single location or at multiple locations. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like. The system and method may be described herein in terms of functional block components, screen shots, optional selections and various processing steps. Such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A computer-based system, comprising:
a processor; and
a memory coupled to the processor and storing instructions that when executed by the processor, configure the processor to:
ingest tables in different storage formats into a database;
generate a catalog identifying data assets stored within the tables, respective storage formats of the data assets, and respective table identifiers of tables where the data assets are stored in the database based on at least one of the ingested tables;
receive a search query that comprises an identifier of a data asset via an online marketplace;
search the catalog based on the identifier of the data asset included in the search query to identify a table where the data asset is stored in the database;
display table data of the data asset from the identified table as a selectable card via a user interface of the online marketplace, in response to the search query, wherein the selectable card comprises a description of the data asset and a matching percentage value; and
in response to the selectable card being selected via the user interface, display additional information about the data asset within the selectable card.

2. The computer-based system recited in claim 1, wherein the processor is further configured to:
identify characteristics of a user that requested the search query;
determine a data asset which is relevant to the user; and
automatically display the data asset to the user via the user interface.

3. The computer-based system as recited in claim 2, wherein the processor is further configured to identify another user with a similar attribute to the user, retrieve a suggested data asset which is relevant to the another user, and display the suggested data asset to the user via the user interface.

4. The computer-based system as recited in claim 1, wherein the processor is configured to identify a variable for a software program in response to the search query.

5. The computer-based system as recited in claim 1, wherein the processor is configured to store the tables on different platforms.

6. The computer-based system as recited in claim 1, wherein the processor is configured to display the table data in card format.

7. The computer-based system as recited in claim 1, wherein the processor is configured to add an identification number to each respective data asset which is used to index the respective data asset.

8. The computer-based system as recited in claim 1, wherein the table comprises a HIVE table.

9. The computer-based system as recited in claim 1, wherein each of the stored data assets comprises a domain and sub-domain.

10. The computer-based system as recited in claim 1, wherein the processor is further configured to create a new data asset, add the new data asset to the catalog, and publish the new data asset to users of the system.

11. A method, comprising:
ingesting tables in different storage formats into a database;
generating a catalog identifying data assets stored within the tables, respective storage formats of the data assets, and respective table identifiers of tables where the data assets are stored in the database based on at least one of the ingested tables;
receiving a search query that comprises an identifier of a data asset via an online marketplace;
searching the catalog based on the identifier of the data asset included in the search query to identify a table where the data asset is stored in the database;
displaying table data of the data asset from the identified table as a selectable card via a user interface of the online marketplace, in response to the search query, wherein the selectable card comprises a description of the data asset and a matching percentage value; and
in response to the selectable card being selected via the user interface, displaying additional information about the data asset within the selectable card.

12. The method as recited in claim 11, wherein the method further comprises:
identifying characteristics of a user that requested the search query;
determining a data asset which is relevant to the user; and
automatically displaying the data asset to the user via the user interface.

13. The method as recited in claim 12, wherein the method further comprises:
identifying another user with a similar attribute to the user,
retrieving a suggested data asset which is relevant to the another user, and
displaying the suggested data asset to the user via the user interface.

14. The method as recited in claim 11, wherein the method further comprises identifying a variable for a software program in response to the search query.

15. The method as recited in claim 11, wherein the ingesting comprises storing the tables on different platforms and different physical locations.

16. The method as recited in claim 11, wherein the displaying comprises displaying the table data in card format.

17. The method as recited in claim 11, wherein the method further comprises adding an identification number to each respective data asset which is used to index the respective data asset.

18. The method as recited in claim 11, wherein the table comprises a HIVE table.

19. The method as recited in claim 11, wherein each of the stored data assets comprises a domain and sub-domain.

20. (canceled)

21. A non-transitory computer-readable medium storing instructions which when executed by a processor cause a processor to perform:
ingesting tables in different storage formats into a database;
generating a catalog identifying data assets stored within the tables, respective storage formats of the data assets, and respective table identifiers of tables where the data assets are stored in the database based on at least one of the ingested tables;
receiving a search query that comprises an identifier of a data asset via an online marketplace;
searching the catalog based on the identifier of the data asset included in the search query to identify a table where the data asset is stored in the database;
displaying table data of the data asset from the identified table as a selectable card via a user interface of the online marketplace, in response to the search query, wherein the selectable card comprises a description of the data asset and a matching percentage value; and
in response to the selectable card being selected via the user interface, displaying additional information about the data asset within the selectable card.
